(19) United States
(12) Patent Application Publication
(10) Pub. No.: US 2002/0059121 A1
(43) Pub. Date: May 16, 2002

(54) System and method for remote warehouse management

(76) Inventors: Pamela R. Schneider, Kent, WA (US); Tammy J. England, Duvall, WA (US); David C. Fawcett, Kirkland, WA (US); Steve E. Haynes, Bellevue, WA (US); Mark E. Linstead, Duvall, WA (US); Shane E. Heneghen, Issaquah, WA (US)

Correspondence Address: NIXON & VANDERHYE P.C., 8th Floor, 1100 North Glebe Road, Arlington, VA, 22201, US

(21) Appl. No.: 09/983,538

(22) Filed: Oct. 24, 2001

Related U.S. Application Data
(60) Provisional application No. 60/247,925, filed on Nov. 14, 2000.

(51) Int. Cl. G06F 17/60

(52) U.S. Cl. 705/28

(57) ABSTRACT

A system for and method of managing product shipment comprises installing a host computer and first communication port coupled to the host computer at a first warehouse. A second communication port is installed at a second warehouse remote from the first warehouse to establish data communication with the first communication port. An rf system is operatively coupled to the second communication port for reading product data and communicating product data to the host computer through the first and second communication ports so that the system can identify products to be shipped from the remote warehouse and verify the shipping accuracy irrespective of how the storage or receipt of the products is tracked.

### CROSS REFERENCE TO RELATED APPLICATION

This application claims the benefit of U.S. Provisional Application No. 60/247,925 filed Nov. 14, 2000, the contents of which are incorporated herein by reference.

### BACKGROUND OF THE INVENTION

1. Field of the Invention

The present invention relates to a system and method for managing inventory, and in particular, a system and method for outsourcing inventory storage to a remotely located warehouse while maintaining control of the inventory management at a central warehouse.

2. Background of Related Art

Certain types of computer systems for managing and controlling the shipment of products from a warehouse are known in the art. For example, the North Bend distribution facility near Seattle, Washington has achieved a remarkable shipping accuracy by tracking products the moment they are received and unloaded from docked trailers. This tracking continues as each product moves through the facility and ultimately into an outgoing trailer. The system at North Bend includes a host computer, an automated storage and retrieval system and a variety of scanners which are capable of reading an identifier of each product and identifiers of storage locations within the facility. The variety of scanners includes bar code readers, input terminals and personnel computers for verifying exactly where each product is at all times while it is in the facility. The scanners can communicate to the host computer by rf transmission or through direct wiring.

The demand for shipments imposed on any single warehouse (hereinafter “central warehouse”) can grow so large that it becomes necessary to outsource storage of some of its products to a remotely located warehouse. This remote warehouse often lacks the infrastructure of the central warehouse for verifying that the shipping accuracy meets minimum expectations (i.e., ensuring that the correct products are being shipped to a minimum degree of expectations). Moreover, the remote warehouse is often an independently owned and operated warehouse and/or has a completely different system and methodology for verifying shipping accuracy. It thus may be necessary to improve shipping accuracy from the remote warehouse if product storage is outsourced. It is often, however, not cost-effective, or even possible for an independent warehouse, to duplicate the (more advanced) inventory control system at the central warehouse to improve the shipping accuracy.

It would thus be beneficial to be able to outsource product storage to a remote warehouse and to implement an inventory management system at the remote warehouse to increase its shipping accuracy without having to duplicate the entire inventory management system of the central warehouse. It would be further beneficial to enable the system at the remote warehouse to communicate and cooperate with the system at the central warehouse to effectively form a single system which manages the shipment from both warehouses with the control of system being arranged at the central warehouse.

### BRIEF SUMMARY OF THE INVENTION

In the exemplary embodiment of the present invention, a method of and system for managing inventory comprises a host computer and a first communication port coupled to the host computer being provided at a first warehouse. A second communication port is provided at a second warehouse remote from the first warehouse to establish data communication with the first communication port. An rf system is operatively coupled to the second communication port for reading data and transmitting the data to the host computer through the first and second communication ports to enable a verification of the shipping accuracy of a shipment of products from the second warehouse irrespective of how the storage of the products at the second warehouse is tracked. The verification of shipping accuracy from the second warehouse can also be accomplished irrespective of how the receipt of the products into the second warehouse is tracked.

To verify the shipping accuracy, the host computer generates an order indicating the products to be shipped in the shipment and transmits the order to the second warehouse through the first and second communication ports. The order received by the second warehouse is waved and a load document or picking list listing the products itemized in the order is generated when the order is waved. The load document or picking list has an identifier which forms a portion of the data that is read to enable the verification of shipping accuracy of the shipment of products from the second warehouse. When the order is waved, shipping labels to be applied to the itemized products are also generated and printed at the second warehouse, each of the shipping labels having a identifier which forms a portion of the data that is read to enable the verification of shipping accuracy.

The products itemized in the order can then be picked based upon the load document or the picking list. The identifier from the load document or picking list and the identifier from each of the shipping labels are read and transmitted to the host computer through the first and second communication ports to enable a verification of the picking accuracy of the products. A loading process is then performed which includes re-reading the identifier from the load document or picking list and identifier from one of the shipping labels and reading a dock number and a trailer number. The re-read identifiers, dock number and trailer number are transmitted to the host computer to enable a verification of a loading accuracy of the products. The verification of the picking accuracy for all of the selected products may be completed before any of the selected products is loaded in the loading process. The host computer is capable of generating a ranking of potential carriers to handle the shipment of the products from the second warehouse. This ranking is transmitted to the second warehouse through the first and second communication ports.

### BRIEF DESCRIPTION OF THE DRAWINGS

These, as well as other advantages of this invention, will be more completely understood and appreciated by careful study of the following more detailed description of the presently preferred embodiments of the invention taken in conjunction with the accompanying drawings, in which:

FIG. 1 is a block diagram illustrating components of the inventory management system in accordance with an exemplary embodiment of the present invention;

FIG. 2 is a flow chart illustrating the steps of the inventory management method in accordance with an exemplary embodiment of the present invention;

FIG. 3 is a flow diagram illustrating the sub-steps of step 300 of FIG. 2;

FIG. 4 is a flow diagram illustrating the sub-steps of step 400 of FIG. 2;

FIG. 5 is a flow diagram illustrating the sub-steps of step 500 of FIG. 2; and

FIG. 6 is a flow diagram illustrating the sub-steps of step 600 of FIG. 2.

### DETAILED DESCRIPTION OF THE INVENTION

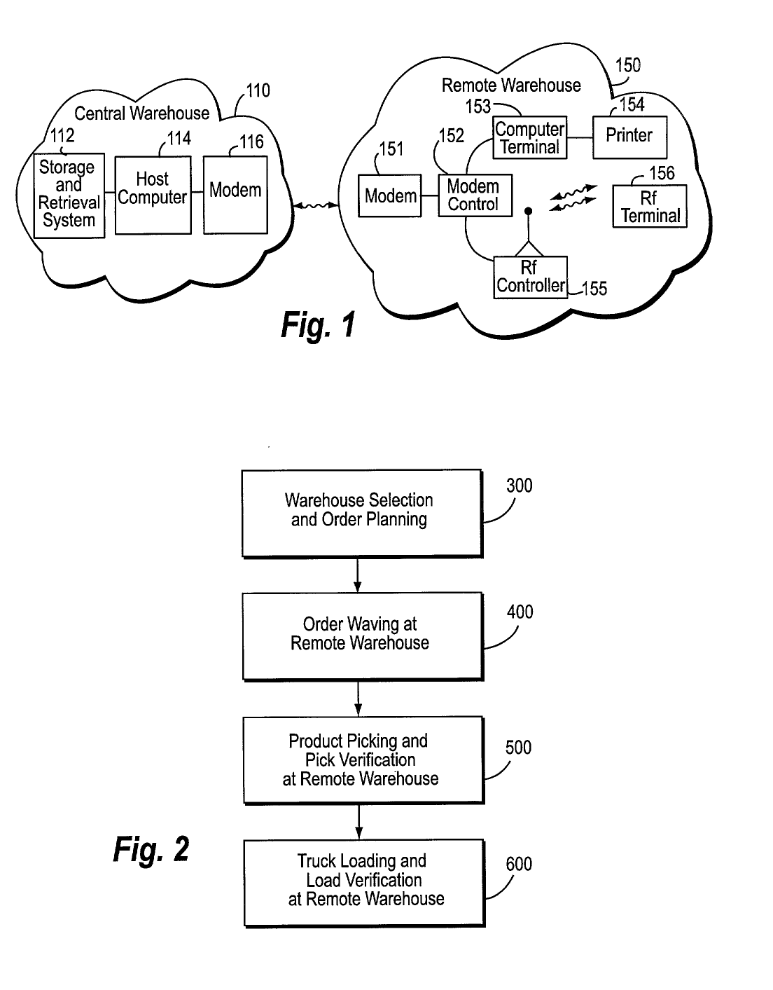

FIG. 1 illustrates a system for managing inventory at a central warehouse 110 and a remote warehouse 150 in accordance with an exemplary embodiment of the present invention. The central warehouse 110 includes a storage and retrieval system 112, a host computer 114 and a modem 116. The storage and retrieval system 112 operatively communicates with and is controlled by the host computer 114. The host computer 114 can be formed by, for example, an IBM® AS/400 computer. The storage and retrieval system 112 can be formed by, for example, a completely automated storage and retrieval system which tracks each product as it moves through the central warehouse 110 beginning at the time that each product is unloaded into the central warehouse 110. In this type of automated storage and retrieval system, scanners including rf terminals and computer terminals can communicate with the host computer 114 to track the receipt and the exact location of each product at any time while it is in the central warehouse 110. A high degree of shipping accuracy may thus be achieved for products shipped from the central warehouse 110 through the storage and retrieval system 112 and the host computer 114.

The modem 116 of the central warehouse 110 is operatively connected to the host computer 114 and forms a port to communicate with a modem 151 which forms a port in the remote warehouse 150. Through modems 116, 151, a high speed dedicated data line can be formed to transmit/receive information between the host computer 114 of central warehouse 110 and the remote warehouse 150. In addition to the modem 151, the remote warehouse 150 includes a modem control 152, a computer terminal 153, a printer 154, a rf controller 155 and a rf terminal 156. The modem 151 is operatively connected to the modem control 152 which is itself operatively connected to the computer terminal 153, the printer 154 and the rf controller 155. The rf controller 155 communicates with the rf terminal 156 via rf transmission/reception. The rf terminal 156 preferably comprises a portable hand-held rf unit for scanning bar codes and entering data for the purpose of picking and loading products as a part of a shipping process from the remote warehouse 150.

The remote warehouse 150 is physically separate from the central warehouse 110 and can be owned and operated by the same entity owning and operating the central warehouse 110 or a by completely independent entity. By outsourcing some of the product storage to a remote warehouse 150, transit time and transportation costs of shipping products to customers may be reduced and product availability may be enhanced due to increased total storage space. The inventory management system enables the remote warehouse 150 to identify products being shipped and to verify the shipping accuracy to a high degree, possibly as high as that of the central warehouse 110, without duplicating all of the infrastructure of the central warehouse 110. For example, the remote warehouse 150 does not necessarily need to include another host computer 114 or the same storage and retrieval system 112. Since the control of the system may be provided by the host computer 114 in the central warehouse 110, the number of remote warehouse personal needed to verify the shipping accuracy from the remote warehouse 150 is minimized.

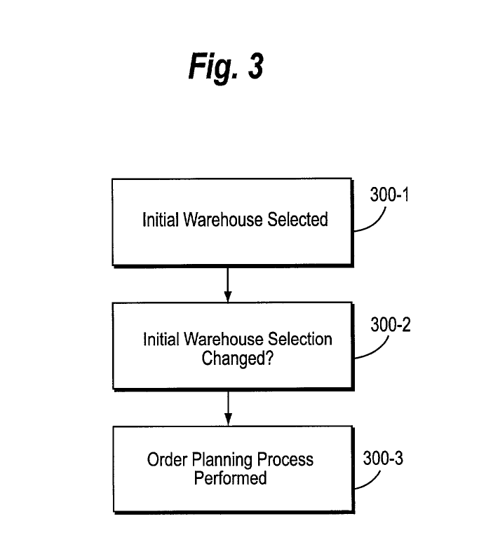

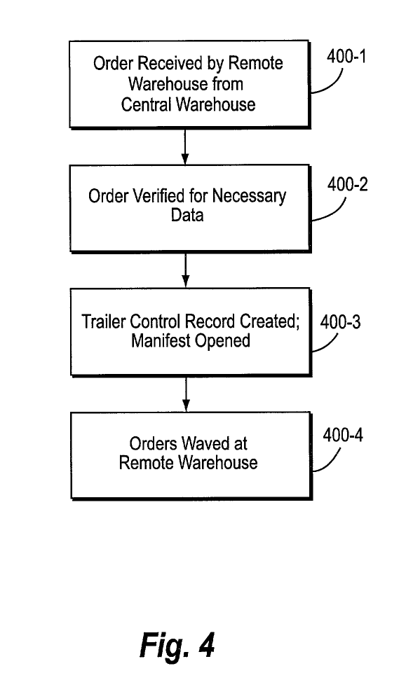

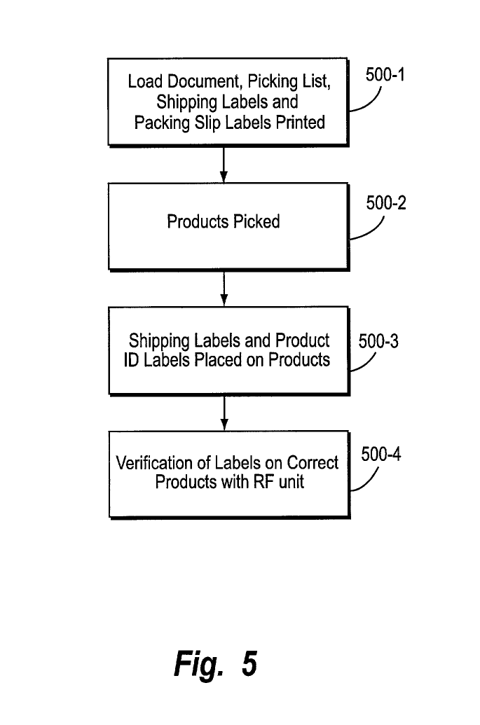

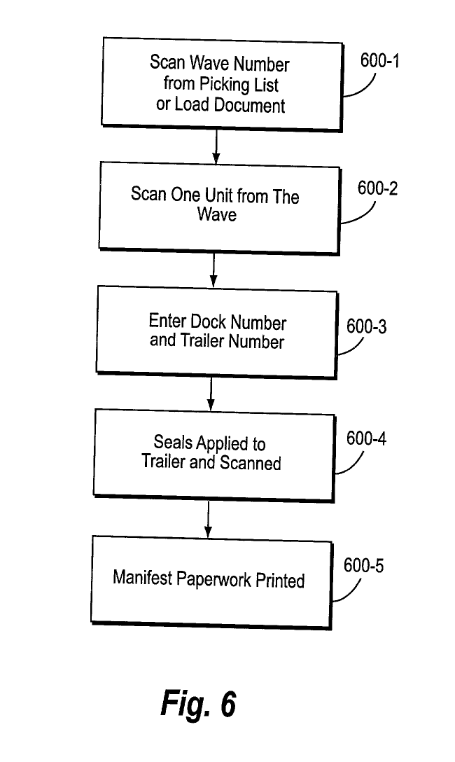

FIG. 2 generally illustrates the steps for managing the inventory at the remote warehouse 150 in accordance with an exemplary embodiment of the present invention. The process generally includes the following steps: warehouse selection and order planning (step 300), order waving at the remote warehouse (step 400), product picking and pick verification at the remote warehouse (step 500), and truck loading and load verification at the remote warehouse (step 600). FIGS. 3, 4, 5 and 6 generally illustrate the sub-steps of steps 300, 400, 500 and 600, respectively.

Referring now to FIGS. 1-3, all new orders for products stored at either the central warehouse 110 or the remote warehouse 150 are forwarded to the host computer 114 for processing. The host computer 114 generates a customer invoice and initially selects which of the warehouses 110 or 150 will handle a specific order (step 300-1). If the remote warehouse 150 is selected, inventory will be allocated against that warehouse's work center. As defined by a predetermined set of rules, the order is then either sent directly to the remote warehouse 150 after being processed by the host computer 114 or reviewed by central warehouse personnel before being sent to the remote warehouse 150.

After initially selecting a warehouse, the host computer 114 is capable of changing the initial selection (step 300-2). If the warehouse selection is changed, the inventory will be de-allocated from the initially selected work center and reallocated against the new warehouse's work center, and the order will be reprocessed by host computer 114. If the inventory noted by the order is not available, the order may require further intervention and processing.

One of two order planning processes will then be performed by the host computer 114 depending upon which warehouse is selected to handle the order (step 300-3). The orders to be handled by the central warehouse 110 are routed by the host computer 114 to the storage and retrieval system 112 by a first order planning process and the orders to be handled by the remote warehouse 150 will be routed through a second order planning process. The order planning process for the remote warehouse 150 creates shippable unit records for the order and provides rate shopping for the order. Specifically, the order planning process for the remote warehouse 150 creates a ranking of potential carriers that are capable of transporting products itemized in the order from the remote warehouse 150 based upon the fee rates charged by each. If the order is to be sent directly to the remote warehouse 150 (as discussed above), the modem 116 then transmits all relevant information and data including the ranking of potential carriers to the modem 151 of the remote warehouse 150. If the order is not flagged to go directly to the remote warehouse 150, the order will become available for review by personnel in the central warehouse 110 before being transmitted. When the host computer 114 sends the data reflecting the order to the remote warehouse 150, an order status will be updated in the host computer 114 to reflect that an order has been sent.

The process in which either the central warehouse 110 or the remote warehouse 150 is selected to handle an order is preferably in the control of the central warehouse personnel. That is, when orders are received by the remote warehouse 150, personnel at the remote warehouse 150 may not know specifically why or how the remote warehouse 150 was selected to handle the order. Remote warehouse personnel may thus have limited visibility to the business data of the central warehouse 110 and may be allowed access only to the information necessary to handle the orders sent to the remote warehouse 150. Furthermore, the remote warehouse personnel can be employed to provide regular cycle counts of the remote warehouse inventory and/or remote warehouse inventory can be audited by central warehouse personnel.

Referring now to FIGS. 1, 2 and 4, an order that is received by modem 151 (step 400-1) of the remote warehouse 150 is communicated to the modem controller 152. The host computer 114 verifies that all necessary data has been received (step 400-2). Once that verification is made, the host computer 114 enables remote warehouse personnel to create a trailer control record and open a manifest (step 400-3) by selecting a carrier and hub (if any), the scheduled date of arrival of the carrier, and the load type (dock or pallet). The carrier is selected from the ranking provided from the host computer 114. The trailer control record includes a truck control id number which orders can be waved to rather than a fixed dock, thus allowing remote warehouse personnel some flexibility in assigning the actual physical dock. As will be discussed below, however, the trailer id and the dock number may preferably be entered before the product can be shipped.

Once the truck control id number has been created, the order may be waved at the remote warehouse 150 (step 400-4). The host computer 114 provides a list of all non-waved orders on the computer terminal 153. This permits remote warehouse personnel to select what orders to wave. The host computer 114 reviews the selections made by the remote warehouse personnel and calculates the total cube (i.e., total cubic volume) of the orders to be waved. If there is enough cube remaining in the trailer to accommodate all of the waved orders, the host computer 114 indicates to the remote warehouse personnel to proceed to wave the orders. If there is not enough total cube available in the trailer, the host computer 114 permits the remote warehouse personnel to cancel the request or to have the host computer 114 optimize the cube in the trailer by waving as many orders as possible until the cube limit has been met.

Referring now to FIGS. 1, 2 and 5, once an order has been waved, a load document, a picking list, shipping labels and packing slip labels are printed by the printer 154 (step 500-1) for the products in that wave. A bill of lading can optionally be printed once the order is waved. The load document is a document which will be used in the loading process as a way of confirming that an order being loaded is going into the correct trailer as well as a reference for the remote warehouse personnel to count and organize the shipping labels. A picking list is used to direct the retrieval of product from storage to a dock staging area to be prepared for loading. The shipping labels contains information relevant to shipping including the dock number, item type, whether a packing slip is attached, a unique alphanumeric code and a unit of measure (label for full pallet or labels for individual cases). The packing slip labels provide information such as a alphanumeric code which is unique to an order and a rf scannable bar code to be used during the shipping verification process to insure the packing slip belongs to the label. A bill of lading is a legal document used to indicate what is included on a shipment.

Those products selected in the order will be picked by the remote warehouse personnel using the picking list (or load document) created during the order wave process (step 500-2) and delivered to the staging area. Once the product has been delivered to the staging area, shipping label(s) are manually or automatically applied to the product (step 500-3). A pre-existing pallet id having a bar coded identifier may also be applied to one of the cases on the pallet.

The accuracy of product picking will then be verified using the rf terminal 156 (step 500-4). Specifically, the bar coded wave number from the picking list (or load document) is scanned by the rf terminal 156, then each shipping label and pallet id label (now applied to the product(s)) is scanned followed by the SKU on each product case. As the rf terminal 156 scans a number from a picking list, shipping label or pallet id label, data relating to that label (and hence data relating to either the order being waved, the product(s) and/or pallet to which the label is applied) is transmitted to the host computer 114 through the rf controller 155, modem control 152 and modems 151, 116. For example, after data relating to the wave number is transmitted to the host computer 114, the host computer 114 will then expect that products associated with that wave number will be scanned (i.e., the shipping and/or pallet id labels the host computer 114 expects will be scanned) as part of that wave. The scanning by the rf terminal 156, preferably a hand-held rf unit, enables the host computer 114 to verify that the labels have been correctly applied to each product and that a particular shipping label belongs to the wave being verified.

This product picking verification process will enable a running total to be kept showing how many labels (and hence products) have been scanned and how many labels (and hence products) are left to be scanned to verify the wave being processed. This running total may be displayed on the rf terminal 156. If the unit being scanned is a pallet, the system may display the number of cases on the pallet for visual verification.

If a label is incorrectly placed on a product, an error is generated which must be corrected before the loading can begin. Preferably, only after all of the labels are verified can loading of the products onto a trailer(s) begin. Accordingly, the system preferably incorporates a batch process to verify the shipping accuracy to the extent that picking an entire wave must be verified before any product can be loaded.

Referring now to FIGS. 1, 2 and 6, after all of the labels are verified (i.e., the verification of the picking process is completed), the products may be loaded into a trailer(s) for shipment. In order to verify the accuracy of loading the products into the trailer(s), the wave number from the picking list or load document is scanned (step 600-1) by the rf terminal 156 so that data relating to the wave number is transmitted to the host computer 114 through rf controller 155, modem controller 152 and modems 151, 116. After receiving data relating to the wave number, the host computer 114 will expect that at least one unit associated with that wave number will then be scanned (step 600-2). This unit can include either one shipping label or the pallet id label. The dock number and trailer number may be entered by the remote warehouse personnel (step 600-3) and also transmitted to the host computer 114. The dock number can be, for example, scanned by the rf terminal 156. If the correct units are loaded onto the trailer (as determined by the host computer 114 through the transmitted wave number and transmitted unit(s)), no errors will be detected by the system. The number of units that have been already loaded and that remain to be loaded will be updated as running totals as the products are being loaded into the truck and scanned in turn. When the trailer is full, seals may be applied to the trailer and scanned (step 600-4) and transmitted to the host computer 114. A manifest paperwork is printed by printer 154 and the carrier/truck control record closed (step 600-5).

All of the information regarding the loading and closing of the trailer is provided from the remote warehouse 150 to the host computer 114. The host computer 114 calculates freight adjustments and recalculates any estimated arrival date if necessary and confirms shipment records.

The system and method of the exemplary embodiment verifies the correct shipment of products (i.e., verifies the shipping accuracy) from the remote warehouse in an automated manner including verifying the picking accuracy and loading accuracy in an automated manner. The modem 151, modem control 152, computer terminal 153, printer 154, rf controller 155 and rf terminal 156 of the remote warehouse 150 may be used only for the purpose of managing inventory as it is shipped (although it is certainly possible to use these components of the system for other purposes). It is not necessary that these components be used to track, control or manage the receipt of incoming inventory at the remote warehouse 150 and or to track, control or manage storage of the products. Since the system and method of the exemplary embodiment of the invention is directed to verifying the shipping of the products from the remote warehouse 150, rather than on the verifying receipt or storage of those products in the remote warehouse 150 the system and method could be implemented to verify shipping accuracy even if there were no organized system or method of tracking, controlling or managing receipt or storage of products in the warehouse 150. The accuracy of shipments from the remote warehouse 150 may therefore be verified even if the accuracy of the receipt and storage of the products comprising those shipments are not.

The system and method of the exemplary embodiment may thus verify shipping accuracy including picking accuracy and loading accuracy, independently of any system and method of tracking and/or verifying storage or receipt of product(s) in the warehouse. The system and method are thus highly adaptable and portable and can be implemented into a remote warehouse in a cost effective manner regardless of what type of inventory control and management system for receiving incoming products is implemented at the remote warehouse, and/or what type of system is implemented to track, control or manage storage of the products. The components installed at the remote warehouse 150 can be similarly installed at another warehouse so that multiple remote warehouses can be controlled with the host computer 114 at the central warehouse 110.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of managing inventory comprising:
providing a host computer at a first warehouse;
operatively coupling a first communication port to the host computer, the first communication port being arranged at the first warehouse;
providing a second communication port at a second warehouse remote from the first warehouse to establish data communication with the first communication port; and
verifying a shipping accuracy of a shipment of products from the second warehouse irrespective of how a storage of the products at the second warehouse is tracked, the verifying including reading data at the second warehouse and transmitting the data to the host computer via the first and second communication ports.

2. A method of managing inventory according to claim 1, wherein verifying the shipping accuracy further includes generating an order indicating products to be shipped in the shipment and transmitting data relating to the order from the host computer to the second warehouse through the first and second communication ports.

3. A method of managing inventory according to claim 2, wherein verifying the shipping accuracy further includes waving the order and generating a load document or a picking list when the order is waved, the load document or picking list having an identifier which forms a portion of the data read at the second warehouse.

4. A method of managing inventory according to claim 3, wherein verifying the shipping accuracy further includes printing shipping labels to be applied to the products upon the waving of the order, each of the shipping labels having an identifier which forms a portion of the data read at the second warehouse.

5. A method of managing inventory according to claim 4, wherein verifying the shipping accuracy further includes picking the products based upon the load document or the picking list, reading the identifier from the load document or picking list, reading the identifier from each of the shipping labels, and transmitting data relating to the read identifiers to the host computer through first and second communication ports to enable a verification of a picking accuracy of the products.

6. A method of managing inventory according to claim 5, wherein verifying the shipping accuracy further includes performing a loading process comprising re-reading the identifier from the load document or picking list, rereading the identifier from one of the shipping labels, and transmitting data relating to the re-read identifiers to the host computer through the first and second communication ports to enable a verification of a loading accuracy of the products.

7. A method of managing inventory according to claim 6, wherein the verification of picking accuracy for all of the products in the order must be completed before the loading process begins.

8. A method of managing inventory according to claim 6, wherein the loading process further comprises reading and transmitting data relating to a dock number and a trailer number to the host computer through the first and second communication ports.

9. A method of managing inventory according to claim 1, wherein reading the data is accomplished using a hand-held rf unit.

10. A method of managing inventory according to claim 1, wherein verifying the shipping accuracy further includes generating a ranking of carriers to handle the shipment of products, and transmitting the ranking from the host computer to the second warehouse through the first and second communication ports.

11. A method of managing inventory comprising:
providing a host computer at a first warehouse;
operatively coupling a first communication port to the host computer, the first communication port being arranged at the first warehouse;
providing a second communication port at a second warehouse remote from the first warehouse to establish data communication with the first communication port;
verifying a shipment of products from the second warehouse irrespective of how a receipt of the products into the second warehouse is tracked, the verifying including reading data at the second warehouse and transmitting the data to the host computer via the first and second communication ports.

12. A method of managing inventory according to claim 11, wherein verifying the shipping accuracy further includes generating an order indicating products to be shipped in the shipment and transmitting data relating to the order from the host computer to the second warehouse through the first and second communication ports.

13. A method of managing inventory according to claim 12, wherein verifying the shipping accuracy further includes waving the order and generating a load document or a picking list when the order is waved, the load document or picking list having an identifier which forms a portion of the data read at the second warehouse.

14. A method of managing inventory according to claim 13, wherein verifying the shipping accuracy further includes printing shipping labels to be applied to the products upon the waving of the order, each of the shipping labels having an identifier which forms at least a portion of the data read at the second warehouse.

15. A method of managing inventory according to claim 14, wherein verifying the shipping accuracy further includes picking the products based upon the load document or the picking list, reading the identifier from the load document or picking list, reading the identifier from each of the shipping labels, and transmitting data relating to the read identifiers to the host computer through the first and second communication ports to enable a verification of a picking accuracy of the products.

16. A method of managing inventory according to claim 15, wherein verifying the shipping accuracy further includes performing a loading process comprising re-reading the identifier from the load document or picking list, rereading the identifier from one of the shipping labels, and transmitting data relating to the re-read identifiers to the host computer through the first and second communication ports to enable a verification of a loading accuracy of the products.

17. A method of managing inventory according to claim 16, wherein the verification of picking accuracy for all of the products in the order must be completed before the loading process begins.

18. A method of managing inventory according to claim 16, wherein the loading process further comprises reading and transmitting data relating to a dock number and a trailer number to the host computer through the first and second communication ports.

19. A method of managing inventory according to claim 1 1, wherein reading the data is accomplished using a hand-held rf unit.

20. A method of managing inventory according to claim 11, wherein verifying the shipping accuracy further includes generating a ranking of carriers to handle the shipment of products, and transmitting the ranking from the host computer to the second warehouse through the first and second communication ports.

21. A system for managing inventory comprising:
a host computer, the host computer being arranged at a first warehouse;
a first communication port coupled to the host computer, the first communication port being arranged at the first warehouse;
a second communication port for establishing data communication with the first communication port, the second communication port being arranged at a second warehouse remote from the first warehouse;
an rf system operatively coupled to the second communication port, the rf system being capable of reading data and transmitting the data to the host computer through the first and second communication ports to enable the system to verify a shipping accuracy of products to be shipped from the second warehouse irrespective of how a storage of the products at the second warehouse is tracked.

22. A system for managing inventory according to claim 21, wherein the host computer is capable of generating a ranking of potential carriers to be used to carry a shipment of the products and transmitting the ranking to the rf system through the first and second communication ports.

23. A system for managing inventory according to claim 21, wherein the rf system includes an rf controller operatively coupled to the second communication port and a hand-held rf unit for reading the data and transmitting the data to the rf controller.

24. A system for managing inventory according to claim 21, wherein the rf system is capable of reading and transmitting data to said host computer to enable said system to verify a picking accuracy of products to be shipped from the second warehouse.

25. A system for managing inventory comprising:
a host computer, the host computer being arranged at a first warehouse;
a first communication port coupled to the host computer, the first communication port being arranged at the first warehouse;
a second communication port for establishing data communication with the first communication port, the second communication port being arranged at a second warehouse remote from the first warehouse;
an rf system operatively coupled to the second communication port, the rf system being capable of reading data and transmitting the data to the host computer through the first and second communication ports to enable the system to verify shipping accuracy of products to be shipped from the second warehouse irrespective of how a receipt of the products into the second warehouse is tracked.

26. A system for managing inventory according to claim 25, wherein the host computer is capable of generating a ranking of potential carriers to be used to carry a shipment of the products and transmitting the ranking to the rf system through the first and second communication ports.

27. A system for managing inventory according to claim 26, wherein the rf system includes an rf controller operatively coupled to the second communication port and a hand-held rf unit for reading the data and transmitting the data to the rf controller.

28. A system for managing inventory according to claim 25, wherein the rf system is capable of reading and transmitting data to the host computer to enable said system to verify a picking accuracy of products to be shipped from the second warehouse.

29. A method of managing inventory according to claim 1, wherein verifying a shipping accuracy includes verifying at least one of a picking accuracy and a loading accuracy of products to be shipped from the second warehouse using data transmitted to the host computer via the first and second communication port.

30. A method of managing inventory according to claim 11, wherein verifying a shipping accuracy includes verifying at least one of a picking accuracy and a loading accuracy of products to be shipped from the second warehouse using data transmitted to the host computer via the first and second communication port.

31. A method of managing inventory comprising:
providing a host computer accessible to a communication system, the communication being arranged in a warehouse remote from the host computer for data transmission and reception with the host computer; and
verifying a shipping accuracy of a shipment of product(s) from the warehouse irrespective of how storage of the product(s) at the warehouse is tracked, the verifying including reading data using the communication system at the warehouse and transmitting the read data to the host computer.

32. A method of managing inventory according to claim 31 further comprising arranging the host computer in another warehouse remote from the warehouse in which the communication system is arranged.

33. A method of managing inventory according to claim 31, further comprising verifying at least one of a picking accuracy and a loading accuracy of product(s) to be shipped from the warehouse using data transmitted by the communication system to the host computer.

34. A method of managing inventory comprising:
providing a host computer accessible to a communication system, the communication system being arranged in a warehouse remote from the host computer for data transmission and reception with the host computer; and
verifying a shipping accuracy of a shipment of product(s) from the warehouse independently from any tracking of storage of the product(s) at the warehouse, the verifying including reading data using the communication system at the warehouse and transmitting the read data to the host computer.

35. A method of managing inventory according to claim 34 further comprising arranging the host computer in another warehouse remote from the warehouse in which the communication system is arranged.

36. A method of managing inventory according to claim 31, further comprising verifying at least one of a picking accuracy and a loading accuracy of product(s) to be shipped from the warehouse using data transmitted by the communication system to the host computer, the at least one of the picking accuracy and loading accuracy being verified independently of any tracking of the storage of the product(s).

37. A method of managing inventory comprising:
providing a host computer accessible to a communication system, the communication system being arranged in a warehouse remote from the host computer for data transmission and reception with the host computer;
verifying a shipping accuracy of a shipment of product(s) from the warehouse irrespective of how receipt of the product(s) into the warehouse is tracked, the verifying including reading data using the communication system at the warehouse and transmitting the read data to the host computer.

38. A method of managing inventory according to claim 37 further comprising arranging the host computer in another warehouse remote from the warehouse in which the communication system is arranged.

39. A method of managing inventory according to claim 37, further comprising verifying at least one of a picking accuracy and a loading accuracy of product(s) to be shipped from the warehouse irrespective of how receipt the product(s) into the warehouse is tracked.

40. A method of managing inventory comprising:
providing a host computer accessible to a communication system, the communication system being arranged in a warehouse remote from the host computer for data transmission and reception with the host computer; and
verifying a shipping accuracy of a shipment of product(s) from the warehouse independently from any tracking of receipt of the product(s) into the warehouse, the verifying including reading data using the communication system at the warehouse and transmitting the read data to the host computer.

41. A method of managing inventory according to claim 40 further comprising arranging the host computer in another warehouse remote from the warehouse in which the communication system is arranged.

42. A method of managing inventory according to claim 40, further comprising verifying at least one of a picking accuracy and a loading accuracy of product(s) to be shipped from the warehouse using data transmitted by a communication system to the host computer, the at least one of the picking accuracy and loading accuracy being verified independently of any tracking of the receipt of product(s) into the warehouse.
